(19) United States
(12) Patent Application Publication
(10) Pub. No.: US 2019/0144202 A1
(43) Pub. Date: May 16, 2019

(54) Refuse Organizing Assembly

(71) Applicants: Cynthia Ignacio, Collingwood (CA); Tomaz Senk, Collingwood (CA)

(72) Inventors: Cynthia Ignacio, Collingwood (CA); Tomaz Senk, Collingwood (CA)

(21) Appl. No.: 15/813,294

(22) Filed: Nov. 15, 2017

(51) Int. Cl. B65F 1/00

(52) U.S. Cl. CPC B65F 1/006; B65F 1/004

(57) ABSTRACT

A refuse organizing assembly includes a box that may be positioned on the support surface and the box has a plurality of compartments therein. A first container is provided and recyclable refuse is placed in the first container for garage collection. The first container is removably positioned in a selected one of the compartments. A second container is provided and compostable refuse is placed in the second container for garbage collection. The second container is removably positioned in a selected one of the compartments. A third container is provided and non-recyclable refuse is placed in the third container for garbage collection. The third container is removably positioned in a selected one of the compartments.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to organizing devices and more particularly pertains to a new organizing device for organizing refuse into recyclable categories.

### BRIEF SUMMARY OF THE INVENTION

An embodiment of the disclosure meets the needs presented above by generally comprising a box that may be positioned on the support surface and the box has a plurality of compartments therein. A first container is provided and recyclable refuse is placed in the first container for garage collection. The first container is removably positioned in a selected one of the compartments. A second container is provided and compostable refuse is placed in the second container for garbage collection. The second container is removably positioned in a selected one of the compartments. A third container is provided and non-recyclable refuse is placed in the third container for garbage collection. The third container is removably positioned in a selected one of the compartments.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a refuse organizing assembly according to an embodiment of the disclosure.

FIG. 2 is a front phantom view of an embodiment of the disclosure.

FIG. 3 is a cross sectional view taken along line 3-3 of FIG. 1 of an embodiment of the disclosure.

FIG. 4 is an exploded perspective view of an embodiment of the disclosure.

FIG. 5 is a top view of a box of an embodiment of the disclosure.

### DETAILED DESCRIPTION OF THE INVENTION

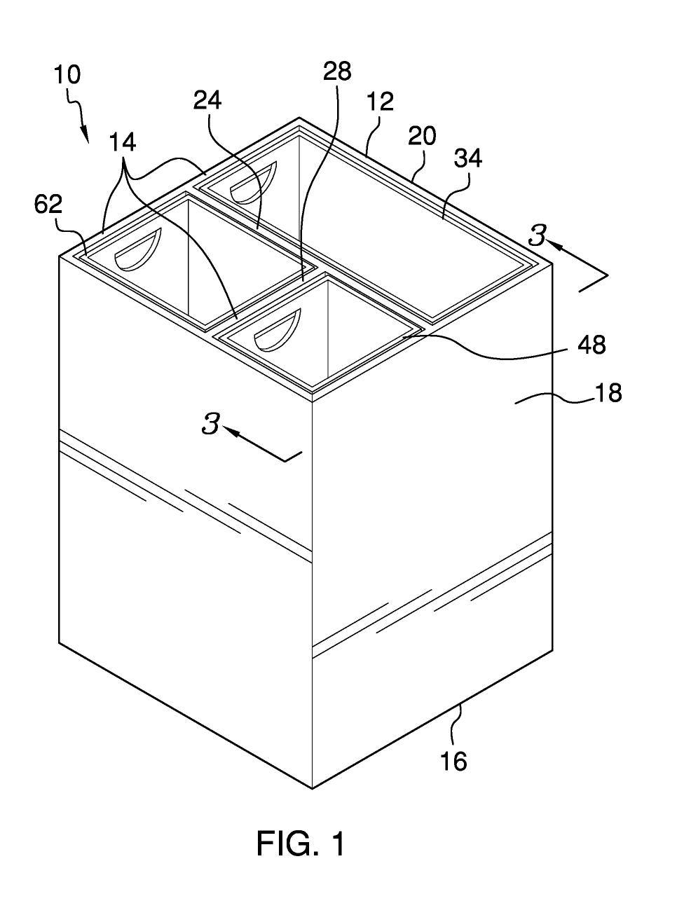

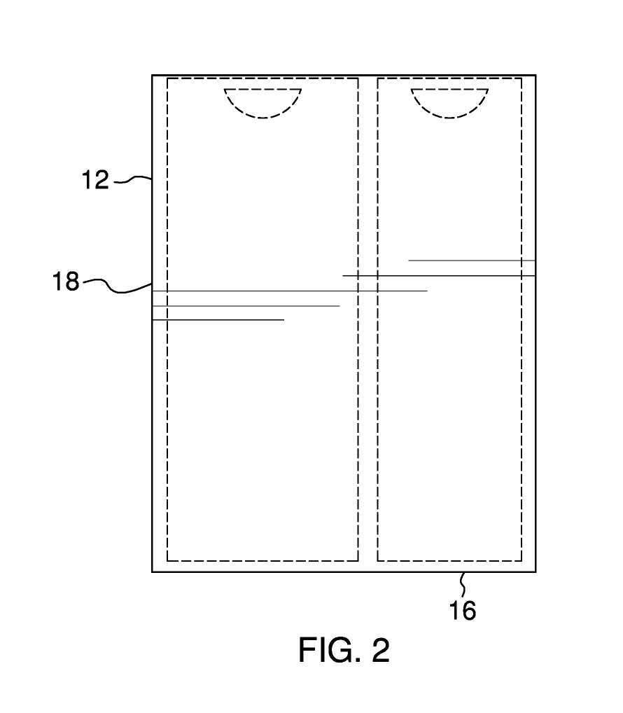

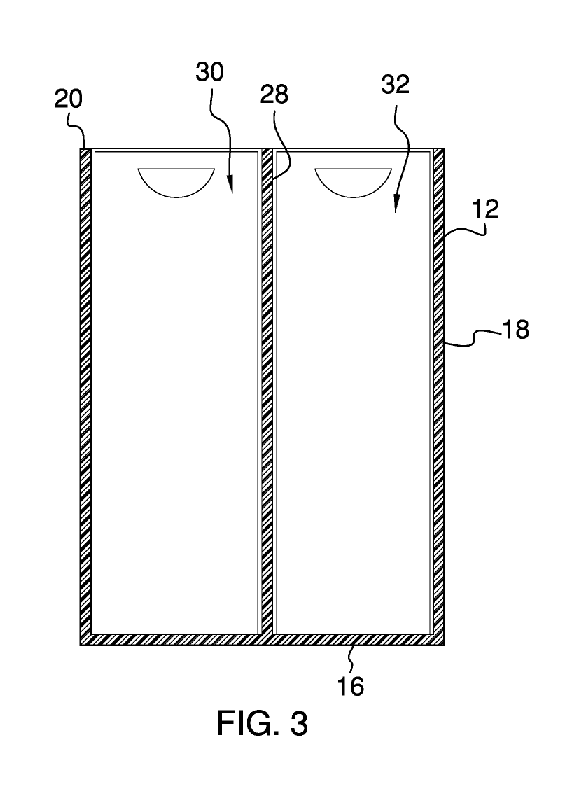

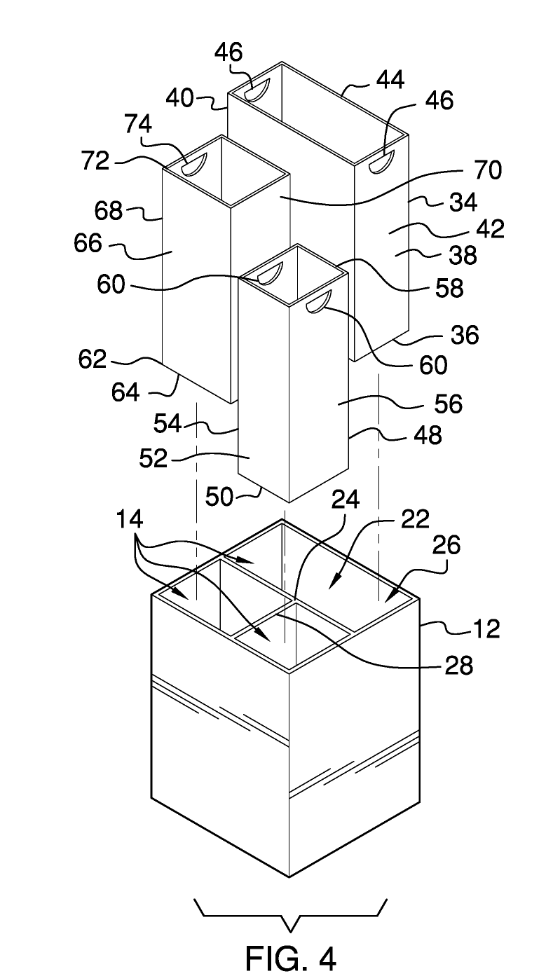

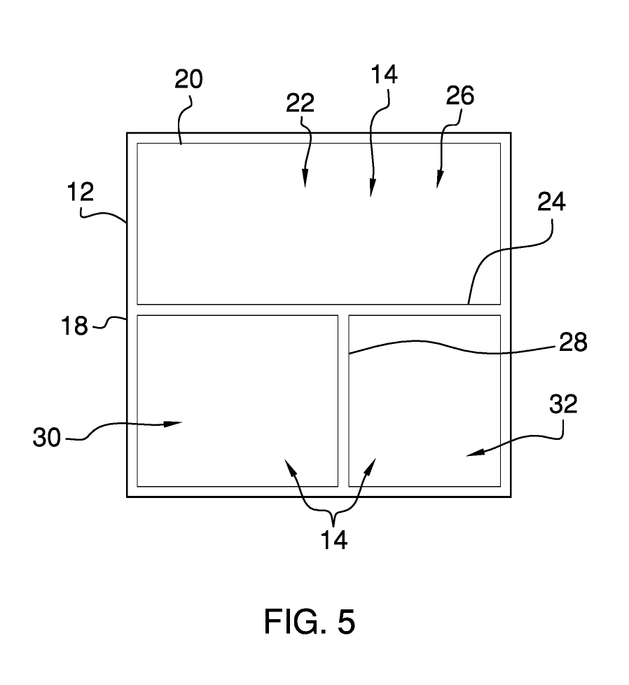

With reference now to the drawings, and in particular to FIGS. 1 through 5 thereof, a new organizing device embodying the principles and concepts of an embodiment of the disclosure and generally designated by the reference numeral 10 will be described.

As best illustrated in FIGS. 1 through 5, the refuse organizing assembly 10 generally comprises a box 12 that may be positioned on a support surface such as ground or the like. Additionally, the box 12 may be positioned outside. The box 12 has a plurality of compartments 14 therein, a bottom wall 16 and an outer wall 18 extending upwardly therefrom. The outer wall 18 has a distal edge 20 with respect to the bottom wall 16 to define an opening 22 into the box 12. The box 12 may have a length, a width and a height ranging between approximately 90.0 cm and 120.0 cm.

A first divider 24 extends between opposite sides of the outer wall 18 to define a first one 26 of the compartments 14 in the box 12. The first divider 24 extends between the bottom wall 16 and the distal edge 20. The first divider 24 may be centrally positioned in the box 12 such that the first compartment 26 has a volume that is equal to 50% of the volume of the box 12. A second divider 28 extends between the first divider 24 and the outer wall 18 to define a second one 30 of the compartments 14 and a third one 32 of the compartments 14 in the box 12. The second divider 28 may be centrally positioned on the first divider 24 such that each of the first and second compartment 30s 14 has a volume that is equal to 25% of the volume of the box 12.

A first container 34 is provided and recyclable refuse is selectively placed in the first container 34. The first container 34 is removably positioned in a selected one of the compartments 14. The first container 34 has a basal wall 36 and a perimeter wall 38 extending upwardly therefrom. Additionally, the perimeter wall 38 has a first lateral side 40, a second lateral side 42 and a distal edge 44 with respect to the basal wall 36. The perimeter wall 38 has a pair of openings 46 extending therethrough and each of the openings 46 is selectively gripped for removing and replacing the first container 34 in the box 12. Each of the openings 46 is positioned on an associated one of the first lateral side 40 and the second lateral side 42. Moreover, each of the opening 22s is spaced from the distal edge 20 of the perimeter wall 38 and the first container 34 is slidably positioned in the first compartment 26.

A second container 48 is provided and compostable refuse is selectively placed in the second container 48. The second container 48 is removably positioned in a selected one of the compartments 14. The second container 48 has a basal wall 50 and a perimeter wall 52 extending upwardly therefrom. Additionally, the perimeter wall 52 of the second container 48 has a first lateral side 54, a second lateral side 56 and a distal edge 58 with respect to the basal wall 50. The perimeter wall 52 of the second container 48 has a pair of openings 60 extending therethrough and each of the openings 60 in the second container 48 is gripped for removing and replacing the second container 48 in the box 12. Each of the openings 60 in the second container 48 is positioned on an associated one of the first lateral side 54 and the second lateral side 56 of the second container 48. Moreover, each of the openings 60 of the second container 48 is spaced from the distal edge 58 of the perimeter wall 52 of the second container 48 and the second container 48 is slidably positioned in the second compartment 30.

A third container 62 is provided and non-recyclable refuse is selectively placed in the third container 62. The third container 62 is removably positioned in a selected one of the compartments 14. The third container 62 has a basal wall 64 and a perimeter wall 66 extending upwardly therefrom and the perimeter wall 66 of the third container 62 has a first lateral side 68, a second lateral side 70 and a distal edge 72 with respect to the basal wall 64. The perimeter wall 66 of the third container 62 has a pair of openings 74 extending therethrough and each of the openings 74 in the third container 62 may be gripped. Each of the openings 74 in the third container 62 is positioned on an associated one of the first lateral side 68 and the second lateral side 70 of the third container 62. Moreover, each of the openings 74 of the third container 62 is spaced from the distal edge 72 of the perimeter wall 66 of the third container 62 and the third container 62 is slidably positioned in the third compartment 32. Each of the first 34, second 48 and third 62 containers may be manufactured with a unique color with respect to each other.

In use, the recyclable refuse is placed in the first container 34 for garbage collection. The first container 34 is selectively placed in the first compartment 26 of the box 12 to store the first container 34. The compostable refuse is placed in the second container 48 for garbage collection. Additionally, the second container 48 is selectively placed in the second compartment 30 of the box 12 to store the second container 48. The non-recyclable refuse is placed in the third container 62 for garbage collection. The third container 62 is selectively placed in the third compartment 32 of the box 12 to store the third container 62.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A refuse organizing assembly being configured to store refuse in selected categories, said assembly comprising:
a box being configured to be positioned on the support surface, said box having a plurality of compartments therein;
a first container being configured to contain recyclable refuse, said first container being removably positioned in a selected one of said compartments;
a second container being configured to contain compostable refuse, said second container being removably positioned in a selected one of said compartments; and
a third container being configured to contain non-recyclable refuse, said third container being removably positioned in a selected one of said compartments.

2. The assembly according to claim 1, wherein said box has a bottom wall and an outer wall extending upwardly therefrom, said outer wall having a distal edge with respect to said bottom wall to define an opening into said box.

3. The assembly according to claim 2, wherein said box has a first divider extending between opposite sides of said outer wall to define a first one of said compartments in said box.

4. The assembly according to claim 3, wherein said box has a second divider extending between said first divider and said outer wall to define a second one of said compartments and a third one of said compartments in said box.

5. The assembly according to claim 3, wherein said first container has a basal wall and a perimeter wall extending upwardly therefrom, said perimeter wall having a first lateral side, a second lateral side and a distal edge with respect to said basal wall, said perimeter wall having a pair of openings extending therethrough wherein each of said openings is configured to be gripped, each of said openings being positioned on an associated one of said first lateral side and said second lateral side, each of said openings being spaced from said distal edge of said perimeter wall, said first container being slidably positioned in said first compartment.

6. The assembly according to claim 4, further comprising said second container having a basal wall and a perimeter wall extending upwardly therefrom, said perimeter wall of said second container having a first lateral side, a second lateral side and a distal edge with respect to said basal wall, said perimeter wall of said second container having a pair of openings extending therethrough wherein each of said openings in said second container is configured to be gripped, each of said openings in said second container being positioned on an associated one of said first lateral side and said second lateral side of said second container, each of said openings of said second container being spaced from said distal edge of said perimeter wall of said second container, said second container being slidably positioned in said second compartment.

7. The assembly according to claim 4, further comprising said third container having a basal wall and a perimeter wall extending upwardly therefrom, said perimeter wall of said third container having a first lateral side, a second lateral side and a distal edge with respect to said basal wall, said perimeter wall of said third container having a pair of openings extending therethrough wherein each of said openings in said third container is configured to be gripped, each of said openings in said third container being positioned on an associated one of said first lateral side and said second lateral side of said third container, each of said openings of said third container being spaced from said distal edge of said perimeter wall of said third container, said third container being slidably positioned in said third compartment.

8. A refuse organizing assembly being configured to store refuse in selected categories, said assembly comprising:
a box being configured to be positioned on the support surface, said box having a plurality of compartments therein, said box having a bottom wall and an outer wall extending upwardly therefrom, said outer wall having a distal edge with respect to said bottom wall to define an opening into said box, said box having a first divider extending between opposite sides of said outer wall to define a first one of said compartments in said box, said box having a second divider extending between said first divider and said outer wall to define a second one of said compartments and a third one of said compartments in said box; and
a first container being configured to contain recyclable refuse, said first container being removably positioned in a selected one of said compartments, said first container having a basal wall and a perimeter wall extending upwardly therefrom, said perimeter wall having a first lateral side, a second lateral side and a distal edge with respect to said basal wall, said perimeter wall having a pair of openings extending therethrough wherein each of said openings is configured to be gripped, each of said openings being positioned on an associated one of said first lateral side and said second lateral side, each of said openings being spaced from said distal edge of said perimeter wall, said first container being slidably positioned in said first compartment;
a second container being configured to contain compostable refuse, said second container being removably positioned in a selected one of said compartments, said second container having a basal wall and a perimeter wall extending upwardly therefrom, said perimeter wall of said second container having a first lateral side, a second lateral side and a distal edge with respect to said basal wall, said perimeter wall of said second container having a pair of openings extending therethrough wherein each of said openings in said second container is configured to be gripped, each of said openings in said second container being positioned on an associated one of said first lateral side and said second lateral side of said second container, each of said openings of said second container being spaced from said distal edge of said perimeter wall of said second container, said second container being slidably positioned in said second compartment; and
a third container being configured to contain non-recyclable refuse, said third container being removably positioned in a selected one of said compartments, said third container having a basal wall and a perimeter wall extending upwardly therefrom, said perimeter wall of said third container having a first lateral side, a second lateral side and a distal edge with respect to said basal wall, said perimeter wall of said third container having a pair of openings extending therethrough wherein each of said openings in said third container is configured to be gripped, each of said openings in said third container being positioned on an associated one of said first lateral side and said second lateral side of said third container, each of said openings of said third container being spaced from said distal edge of said perimeter wall of said third container, said third container being slidably positioned in said third compartment.
